(19) United States
(12) Patent Application Publication
(10) Pub. No.: US 2026/0241867 A1
(43) Pub. Date: Aug. 20, 2026

(54) INTERIOR LINING FOR A TRUNK LID OF A VEHICLE

(71) Applicant: AUDI AG, Ingolstadt (DE)

(72) Inventor: Maximilian KÄTHLER, Ingolstadt (DE)

(73) Assignee: AUDI AG, Ingolstadt (DE)

(21) Appl. No.: 19/447,114

(22) Filed: Jan. 13, 2026

(30) Foreign Application Priority Data
Feb. 20, 2025 (DE) 102025106349.4

(51) Int. Cl. B60R 7/02; B60Q 7/00; B60R 13/01; B62D 25/12

(52) U.S. Cl. CPC B60R 7/02; B60Q 7/00; B60R 13/011; B62D 25/12

(57) ABSTRACT

An interior lining for a vehicle trunk lid with a lining base body and a storage compartment for a warning triangle. The storage compartment is partially bounded on the outside by the lining base body and is open toward a front side of the lining base body. The interior lining is provided with a push button which is designed and/or suitable for a warning triangle inserted into the storage compartment to be held in the storage compartment by the push button in a locked position of the push button, preferably a projection of the push button.

### FIELD

The invention relates to an interior lining for a trunk lid of a vehicle.

### BACKGROUND

From CN 2 16 761 615 U, a generic interior lining for a trunk lid of a vehicle is known. The interior lining includes a lining base body, a compartment for a warning triangle, and a cover for the compartment. The storage compartment is partially bounded to the outside by the lining base body and is open towards the front of the lining base body via a storage compartment opening. The receiving opening can be closed using the cover, which can be removed from the lining base body. To close the storage compartment, the cover engages the lining base body at its first end and is locked to the lining base body at its second end via a bayonet lock.

The interior lining features the cover and the bayonet fitting to hold the warning triangle in the compartment. Due to the many individual parts, the interior lining is expensive to manufacture. Furthermore, the bayonet lock is cumbersome to operate, and the cover must be handled separately when the compartment is open, so the cover can easily be lost.

DE 100 10 988 A1 discloses a vehicle with a warning device. From DE 10 2018 210 988 A1, a lining element with a receptacle for a warning triangle, a tailgate with a lining element and a motor vehicle with such a tailgate are known.

### SUMMARY

The object of the invention is to provide an interior lining for a trunk lid of a vehicle that can be manufactured cost-effectively and in which a warning triangle can be removed from a storage compartment of the interior lining in a simple and user-friendly manner.

According to the invention, an interior lining for a trunk lid of a vehicle is proposed, comprising a lining base body and a storage compartment for a warning triangle, wherein the storage compartment is partially bounded to the outside by the lining base body and is open towards a front of the lining base body. According to the invention, the interior lining has a push button which is designed and/or suitable for holding a warning triangle inserted into the storage compartment in a locking position of the push button, by the push button, preferably a projection of the push button, in the storage compartment. The warning triangle is thus held directly in the storage compartment by the push button. Additional components, such as a lid that holds the warning triangle in the compartment and is fixed to the lining base body via a bayonet lock, are therefore not necessary. In comparison, the interior lining is therefore cheaper to manufacture, and the warning triangle can be easily and user-friendly removed from the storage compartment. Furthermore, this ensures that the warning triangle is reliably held in the compartment even under stress, such as in a crash.

In order to enable the warning triangle to be held in the storage compartment with as few components as possible, a preferred embodiment provides that the interior lining is designed and/or suitable for holding the warning triangle directly and/or immediately by the push button, preferably directly and/or immediately by a projection of the push button, in the storage compartment.

In order to enable the warning triangle to be held in the storage compartment with as few components as possible, a preferred embodiment provides that a projection of the push button, in the locking position and when the warning triangle is inserted into the storage compartment, protrudes into a warning triangle opening bounded on the outside by the warning triangle, so that the warning triangle is preferably held in the storage compartment by the projection of the push button, preferably in a form-fitting manner.

To enable the warning triangle to be removed from the storage compartment as easily as possible simply by pressing the push button, an exemplary embodiment provides that the push button is designed and/or suitable and/or arranged on the lining base body in such a way that the push button can be moved from the locking position to the unlocking position by pressing a projection of the push button towards a rear side of the lining base body, thereby generating a restoring force and elastic deformation, wherein it is preferably provided that the interior lining is designed and/or suitable so that the warning triangle can be removed from the storage compartment without obstructing contours in the unlocking position of the push button.

In order to be able to demold the push button in the tool direction and thus to manufacture the push button simply and therefore cost-effectively, and to make the assembly of the interior lining as simple as possible, in an exemplary embodiment it is provided that a projection of the push button and an annular circumferential edge of the push button are connected together materially and/or in one piece.

In order to maintain the function of a push button in the simplest and most cost-effective way possible, in an exemplary embodiment it is provided that the projection of the push button is connected directly and/or with the same material and/or in a single piece with the annularly surrounding edge of the push button exclusively in the region of a pivot axis.

In order to achieve the push-button functionality of the push button using the simplest and most cost-effective means possible, in an exemplary embodiment it is provided that the push button is attached to the lining base body, preferably a rear wall section of the lining base body, via an annular circumferential edge of the push button.

In order to manufacture the lining round body and the push button with low weight, an exemplary embodiment provides that the material of the locking base body and/or the material of the push button is a plastic, and/or that the locking base body and/or the push button are injection-molded components.

The invention also proposes an arrangement with an interior lining as described above and a warning triangle.

The invention also proposes a vehicle with an interior lining or arrangement as described above.

With the trunk lid closed and/or essentially, the front of the lining base body can face the front of the vehicle. With the trunk lid closed and/or essentially, a rear side of the lining base body can face the rear of the vehicle.

Preferably, the trunk lid is arranged at the rear of the vehicle, and preferably, the trunk lid is designed and/or suitable for closing a rear trunk of the vehicle to the outside by means of the trunk lid. As an alternative, it may be provided that the trunk lid is arranged at the front of the vehicle, wherein it is preferably provided that the trunk lid is designed and/or suitable for closing a front trunk of the vehicle to the outside by means of the trunk lid.

### BRIEF DESCRIPTION OF THE FIGURES

Exemplary embodiments of the invention are explained in more detail below with reference to the attached schematic drawing.

In the figures:

FIG. 1 shows a front view of an interior lining, and

FIG. 2 shows a front view of a push button of the interior lining.

### DETAILED DESCRIPTION

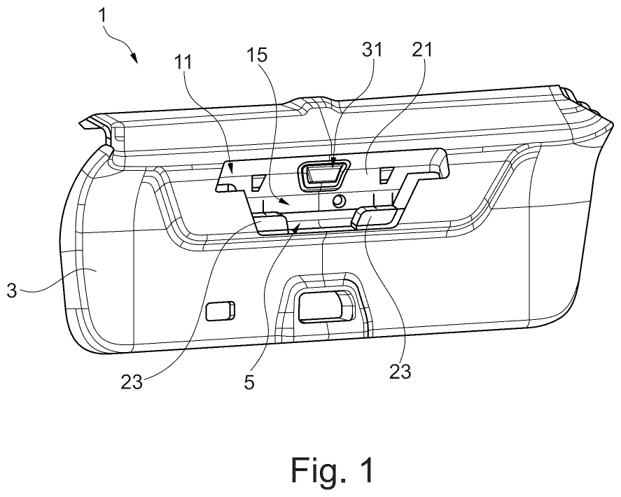

FIG. 1 shows an interior lining 1 attached to a trunk lid of a vehicle, here represented only for example by a tailgate. The trunk lid is located at the rear of the vehicle. The trunk lid allows the rear trunk of the vehicle to be closed off from the outside.

The interior lining 1 has a lining base body 3 with a front side which, when the vehicle trunk lid is closed, essentially points towards the front of the vehicle. With the trunk lid closed, a rear side of the lining base body 3 substantially faces the rear of the vehicle. The lining base body 3 also has an upper side which, when the trunk lid is closed, essentially points upwards relative to the vehicle. The lining base body 3 also has a lower side which, when the trunk lid is closed, essentially points downwards relative to the vehicle.

The interior lining 1 also has a storage compartment 5 for a warning triangle (not shown), which can be inserted into the storage compartment 5. The storage compartment 5 is open in the direction of the upper side of the lining base body 3 via a, preferably substantially, slot-shaped opening section 11 of an opening of the storage compartment 5 and in the direction of the front of the lining base body 3 via a, preferably substantially frustoconical, opening section 15 of the opening of the storage compartment 5. Towards the rear of the lining base body 3, the storage compartment 5 is delimited by a rear wall section 21 of the lining base body 3.

The interior lining 1 also has two retaining tabs 23 which are made of the same material and are integrally connected to the connecting base body 3. The retaining tabs 23 are arranged at the end of the opening section 15 pointing towards the underside of the lining base body 3 and delimit the storage compartment 5 towards the front of the connecting base body 3 to the outside.

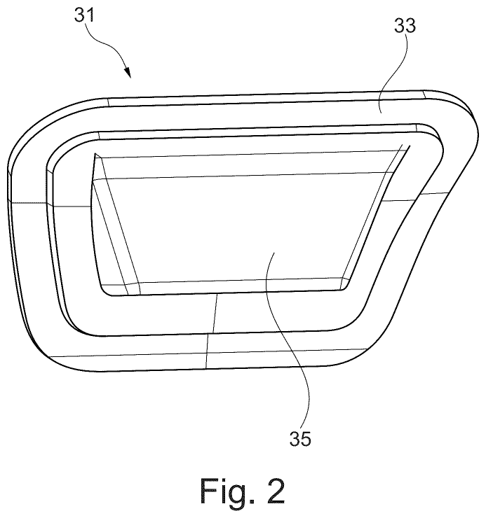

The interior lining 1 also has a push button 31, as shown in FIG. 2. The push button 31 has a annular circumferential edge 33 and a projection 35 arranged radially inside the annular circumferential edge 33. The projection 35 essentially has the shape of a three-sided prism. The projection 35 is connected to the annular circumferential edge 33 only along a pivot axis, preferably materially and in a single piece. In the remaining regions of the projection 35, the projection 35 is not connected to the annularly circumferential edge 33, so that the projection 35 is only flexibly attached to the annular circumferential edge 33 in the region of the pivot axis.

The push button 31 is attached to the lining base body 3 by means of the annular circumferential edge 33, preferably centrally on the rear wall section 21 with respect to the vehicle transverse axis. The projection 35 extends towards the front of the lining base body 3 from the annular circumferential edge 33. The pivot axis extends essentially parallel to the vehicle transverse axis. The push button 31 is also arranged on the lining base body 3 such that the projection 35 faces the underside of the lining base body 3 and the pivot axis faces the upper side of the lining base body 3.

By pressing the projection 35 towards the rear of the lining base body 3, the projection 35 is moved from its locking position, shown in FIGS. 1 and 2, to its unlocking position by elastic deformation of the projection and/or the annular circumferential edge 33 and/or the lining base body 3 about the pivot axis, building up a restoring force. In the locked position, the projection 35 extends completely into the storage compartment 5. In the unlocked position, the projection 35 does not protrude into the storage compartment 5 or only partially.

The following describes how to insert the warning triangle into the storage compartment 5 and how to remove the warning triangle from the storage compartment 5. If the warning triangle is inserted into the storage compartment 5 and the projection is in its locking position, the projection 35 extends into a warning triangle opening, bounded on the outside by the warning triangle, and secures the warning triangle in the storage compartment 5. To remove the warning triangle from the storage compartment 5, the projection 35 can be pressed by the push button 31 towards the rear of the lining base body 3, so that the projection 35 no longer extends into the warning triangle opening and the warning triangle can be pulled out of the storage compartment 5 through the opening section 11 and towards the upper side of the lining base body 3 without obstructing contours. After the warning triangle has been removed from the storage compartment 5, the projection 35 automatically swings back into its locking position by the restoring force.

After use, the warning triangle can be inserted into the storage compartment 5 via the opening section 11, in the direction of the underside of the lining base body 3. When the warning triangle is inserted, the projection 35 is moved by the warning triangle from its locking position to its unlocking position while building up the restoring force. Once the warning triangle is fully inserted into the storage compartment 5, the projection 35 automatically pivots back into its locking position by the restoring force and protrudes into the warning triangle opening, so that the warning triangle is held securely and reliably in the storage compartment 5 by the projection 35.

### LIST OF REFERENCE NUMERALS

1 interior lining
3 lining base body
5 storage compartment
11 opening section
15 opening section
21 rear wall section
23 retaining tab
31 push button
33 edge
35 projection

1. An interior lining for a trunk lid of a vehicle, comprising:
a lining base body, and
a storage compartment for a warning triangle,
wherein the storage compartment is partially bounded to the outside by the lining base body and is open towards a front side of the lining base body,
wherein the interior lining has a push button which is designed and/or suitable to hold a warning triangle inserted into the storage compartment in a locking position of the push button by the push button in the storage compartment.

2. The interior lining according to claim 1, wherein the interior lining is designed and/or suitable to hold the warning triangle directly and/or immediately by the push button, preferably directly and/or immediately by a projection of the push button, in the storage compartment.

3. The interior lining according to claim 1, wherein a projection of the push button in the locking position and when the warning triangle is inserted into the storage compartment projects into a warning triangle opening bounded outwards by the warning triangle, so that preferably the warning triangle is held in the storage compartment by the projection of the push button, preferably in a form-fitting manner.

4. The interior lining according to claim 1, wherein the push button is designed and/or suitable and/or arranged on the lining base body in such a way that the push button can be moved from the locking position to the unlocking position of the push button by pressing a projection of the push button towards a rear side of the lining base body by building up a restoring force and by elastic deformation,
wherein the interior lining is designed and/or suitable so that the warning triangle can be removed from the storage compartment without interference contours in the unlocked position of the push button.

5. The interior lining according to claim 1, wherein a projection of the push button and an annular circumferential edge of the push button are joined together materially and/or in a single piece.

6. The interior lining according to claim 5, wherein the projection of the push button is connected directly and/or materially and/or in a single piece with the annular circumferential edge of the push button exclusively in the region of a pivot axis.

7. The interior lining according to claim 1, wherein the push button is attached to the lining base body, preferably a rear wall section of the lining base body, via an annular circumferential edge of the push button.

8. The interior lining according to claim 1, wherein the material of the locking base body and/or the material of the push button is a plastic, and/or that the locking base body and/or the push button are injection molded components.

9. An arrangement comprising an interior lining according to claim 1 and a warning triangle.

10. A vehicle with an interior lining according to claim 1.

11. The interior lining according to claim 2, wherein a projection of the push button in the locking position and when the warning triangle is inserted into the storage compartment projects into a warning triangle opening bounded outwards by the warning triangle, so that preferably the warning triangle is held in the storage compartment by the projection of the push button, preferably in a form-fitting manner.

12. The interior lining according to claim 2, wherein the push button is designed and/or suitable and/or arranged on the lining base body in such a way that the push button can be moved from the locking position to the unlocking position of the push button by pressing a projection of the push button towards a rear side of the lining base body by building up a restoring force and by elastic deformation,
wherein the interior lining is designed and/or suitable so that the warning triangle can be removed from the storage compartment without interference contours in the unlocked position of the push button.

13. The interior lining according to claim 3, wherein the push button is designed and/or suitable and/or arranged on the lining base body in such a way that the push button can be moved from the locking position to the unlocking position of the push button by pressing a projection of the push button towards a rear side of the lining base body by building up a restoring force and by elastic deformation,
wherein the interior lining is designed and/or suitable so that the warning triangle can be removed from the storage compartment without interference contours in the unlocked position of the push button.

14. The interior lining according to claim 2, wherein a projection of the push button and an annular circumferential edge of the push button are joined together materially and/or in a single piece.

15. The interior lining according to claim 3, wherein a projection of the push button and an annular circumferential edge of the push button are joined together materially and/or in a single piece.

16. The interior lining according to claim 4, wherein a projection of the push button and an annular circumferential edge of the push button are joined together materially and/or in a single piece.

17. The interior lining according to claim 2, wherein the push button is attached to the lining base body, preferably a rear wall section of the lining base body, via an annular circumferential edge of the push button.

18. The interior lining according to claim 3, wherein the push button is attached to the lining base body, preferably a rear wall section of the lining base body, via an annular circumferential edge of the push button.

19. The interior lining according to claim 4, wherein the push button is attached to the lining base body, preferably a rear wall section of the lining base body, via an annular circumferential edge of the push button.

20. The interior lining according to claim 5, wherein the push button is attached to the lining base body, preferably a rear wall section of the lining base body, via an annular circumferential edge of the push button.
